(19) United States
(12) Patent Application Publication
(10) Pub. No.: US 2013/0273999 A1
(43) Pub. Date: Oct. 17, 2013

(54) METHOD FOR SAVING THE STATE OF A PART OF A GAME AND METHOD FOR RESTORING THE CORRESPONDING GAME

(71) Applicants: Fabien Seheux, La Ciotat (FR); Jean-François Martinent, La Ciotat (FR)

(72) Inventors: Fabien Seheux, La Ciotat (FR); Jean-François Martinent, La Ciotat (FR)

(73) Assignee: GEMALTO SA, Meudon (FR)

(21) Appl. No.: 13/880,170

(22) PCT Filed: Oct. 14, 2011
(86) PCT No.: PCT/EP2011/068047

§ 371 Date: Jun. 27, 2013

(30) Foreign Application Priority Data
Oct. 19, 2010 (EP) 10306139.6

(51) Int. Cl. A63F 13/00

(52) U.S. Cl. CPC A63F 13/00
USPC 463/24

(57) ABSTRACT

The invention relates in particular to a method for saving the state of a session of a game played by at least two players, the game including game elements having chips that are capable of contactless communication with a terminal via an interface. The terminal includes a screen, the game consisting of presenting game elements to the interface, each player being identified by the terminal by a game element referred to as the master element. According to the invention, the saving method involves: recording the history of the game session, recording the game elements which have not been in play, if applicable, and recording the game elements in the possession of the players at the time that the game was interrupted, by means of master elements, so as to be able subsequently to resume the game session in the same state in which the game was when interrupted.

The field of the invention is that of electronic games (card games or board games) using contactless game elements, such as contactless cards or contactless figurines. More precisely, the present invention concerns a method for saving the state of a part of a game played by at least two players with such game elements.

Since the advent of electronic games on computers, on smartphones or online, novel types of new games have recently appeared on the market.

The inventors of the present application have imagined using contactless game elements, such as contactless cards for example, representing characters, weapons, defence means, or locomotion means, made available to players so that they can achieve an aim that may be to seize a region or a realm or to seize a treasure.

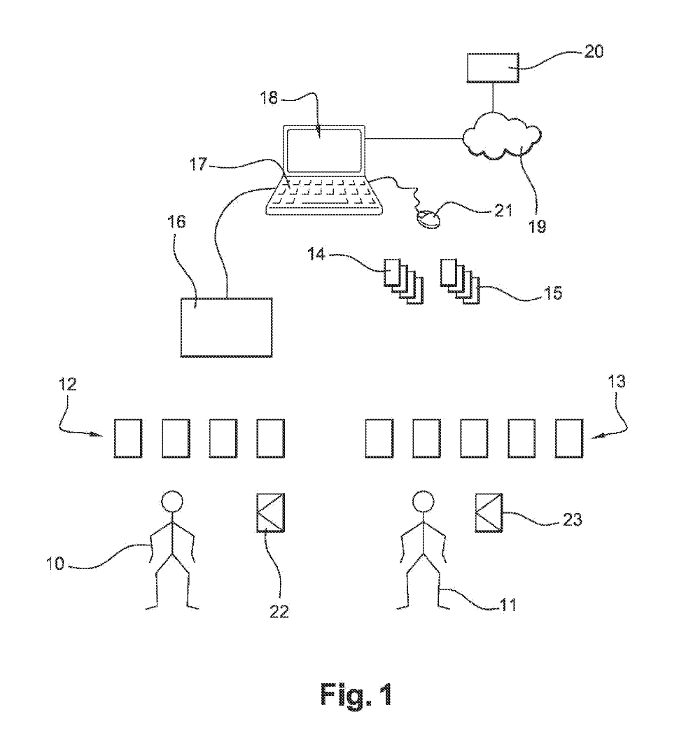

FIG. 1 is a schematic view of such a game.

Two players 10 and 11 use playing cards 12 to 15 to confront each other. The cards 12 represent the hand of the player 10 and the cards 13 that of the player 11. The player 10 has no knowledge of the hand 13 of the player 11 and, conversely, the player 11 has no knowledge of the hand 12 of the player 10. The game also comprises a stock 14 as well as optionally discards 15.

A contactless interface 16 is connected to a terminal 17 provided with a screen 18. Gaming software is for this purpose installed on the terminal 17 or the terminal 17 is connected to a distant server 20 via the Internet 19 and the players play online. The game may be controlled by means of a mouse 21.

The game consists for example, for each player, of in turn placing one of his playing cards 12 and 13 on the interface 16. The player 10 plays one of his cards 12 and then the player 11 plays one of his cards 13. It is then once again the turn of the player 10 and then of the player 11 and so on. When a player cannot play one of his cards, he takes one from the stock 14. If the number of cards of a player becomes too great, he can discard by putting a card in the discards 15.

The rules of the game may be very variable: when a player places a card representing a weapon on the interface 10, he has for example a power superior to that of the other player, who does not have adequate means of defence enabling him to properly counter an attack made with this weapon. He can on the other hand counter with another weapon or use a fast locomotion means enabling him to recover the appropriate means of defence at a place other than the one where he is situated.

Each player may also have to play successively several of his cards. He has for this purpose a game element referred to as the master element (a special card) enabling him to be identified in the game. The master card of the player 10 is referenced 22 and that of the player 11 is referenced 23. These master cards 22, 23 may be placed on the interface 16 before playing one of the playing cards 12 or 13 respectively. If the interface 16 has an anti-collision system, the master card may be played at the same time as the playing card of the corresponding player, the game then automatically recognising the player and the card that he has played.

The game thus continues normally to its end (it finishes in principle with the victory of one of the players). The winner can then place his master card on the interface 16 and it is credited with a larger number of points, the player having won by experience, strength or skill for example.

The value of a master card thus changes over time (the same may apply to a character card), according to the game experiences lived by its holder and the outcome of the game. If its holder is victorious at the end of a part, for example following a fierce combat during which he has suffered wounds, his “health” points credit will be unfavourably affected because of the wounds but he will have gained in strength and experience. If on the other hand its holder has lost a part, his fame will be affected thereby, as well as his state of health and his morale.

The problem posed by this type of game is when it must be interrupted: for example if one of the players must abandon the game because it is too prolonged in the evening or because he has other urgent obligations, he is obliged to cease playing, with of course the agreement of his game partner. The terminal 17 must then be switched off and the cards stored. The part commenced is then lost, the environment also created, and the game experiences, strengths, levels of life, etc are not preserved. It is in fact not possible to take a photograph of the game at the moment of its interruption since the cards that have been played may have an influence on the remainder of the game, for a longer period than one turn. By way of example, a card played at a given moment by a player may give more strength to this player for 3, 5 or even 10 turns. A photograph of the state of play therefore does not make it possible to take account of the true state of the game since some effects due to the cards played may endure over time.

The objective of the present invention is in particular to remedy this drawback.

More precisely, one of the objectives of the invention is to enable players participating in an electronic game using contactless game elements, for example contactless cards, to save the exact state of the game at the moment of its interruption in order to be able to restore it subsequently so as to be able to resume part of the game in the configuration in which the game was situated at the moment of its interruption.

This objective, as well as others that will emerge subsequently, is achieved by means of a method for saving the state of a part of a game played by at least two players, the game comprising game elements with chips able to communicate without contact with a terminal via an interface, the terminal comprising a screen. The game consists of presenting the game elements to the interface, each player being identified by the terminal by a game element referred to as the master element. According to the invention, the saving method consists of:
recording the history of the unfoldment of the part of the game,
recording any game elements that may not have been played,
recording the game elements in the possession of the players at the moment of interruption of the part by means of the master elements,

so as to be able subsequently to resume the part in the same state as it was at the time of the interruption.

In an advantageous embodiment, the game elements consist of contactless cards each comprising a diagram (drawing). Advantageously, the recording of the game elements that have not been played comprises the recording of the game elements included in a stock.

In a preferential embodiment, the recordings are made in one of the master cards.

In an alternative embodiment, the recordings are shared between the master cards of the players.

According to a variant, the recordings are made at the terminal.

The recordings may also be made at a server to which the terminal is connected.

The method according to the invention may also comprise a step of saving the game elements that have been played in a discard.

The invention also concerns a method for restoring part of a game played by at least two players, the game comprising game elements with chips able to communicate without contact with a terminal via an interface, the terminal comprising a screen. The game consists of presenting the game elements to the interface, each player being identified by the terminal by a game element referred to as the master element, the restoration method consisting of:
restoring the history of the unfoldment of the part of the game,
identifying any game elements that may not have been played,
identifying the game elements to be allocated to each of the players by means of the master elements.

Other features and advantages of the present invention will emerge from a reading of the following description of a preferential embodiment, given by way of illustration and non-limitatively, and the accompanying drawings, in which:

FIG. 1 is a schematic view of an electronic game for which the method according to the invention can be applied;

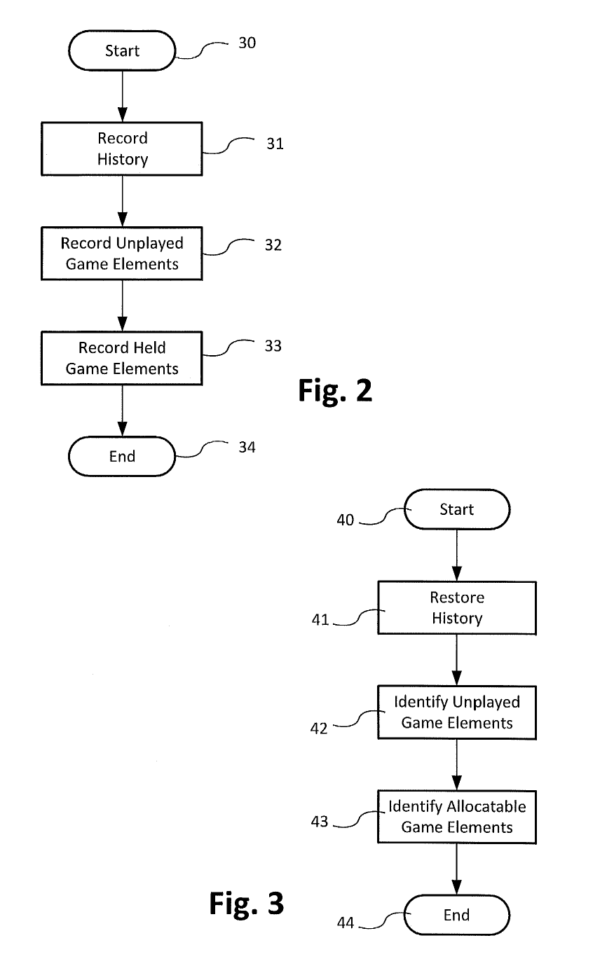

FIG. 2 is a diagram showing the various steps of the saving method according to the invention;

FIG. 3 is a diagram showing the various steps of the restoration method according to the invention.

In the following description, the context will be a card game such as the one described with reference to the prior art in FIG. 1. The invention is however not limited to such a card game and applies in general terms to any game played by at least two players manipulating the game elements with chip able to communicate without contact with a terminal via an interface. By way of example, the game elements may consist of pawns or figurines provided with passive or active tags that can be read by the contactless interface. These tags may optionally each comprise a microprocessor.

The contactless interface may for example be in the form of a contactless mat that can be uncoiled and connected to a terminal provided with a screen. This mat comprises for example several game areas, an antenna being provided under each game area to read and/or write data from or to the contactless game elements.

FIG. 2 is a diagram showing the various steps of the saving method according to the invention.

It will be recalled that each player is identified by the terminal by a game element referred to as the master element, this card (the card of the player) belonging to a player and being particular to him. It is therefore to be distinguished from the other cards, which are playing cards.

Step 30 is a start step.

At the moment when the players decide to interrupt the game, they interact with the terminal 17, for example by means of the mouse 21, in order to indicate to it that the game is to be interrupted. The terminal 17 then proceeds with a recording, during a step 31, of the history of the unfoldment of the part of the game. This recording may be done as the game that has been interrupted unfolds. During a step 32, a recording is made of any game elements that may not have been played, such as for example the stock. This recording may consist of successively depositing on the contactless surface all the game elements that have not been played. The players interact with the terminal 17 by means of the mouse in order to indicate to it that they will for example begin with the stock and deposit on the contactless interface each of the cards constituting this stock. Optionally, once the cards of the stock have been recorded, the players indicate to the terminal that they will now record the cards of the discards (the cards played) and place each of the cards from this discard on the contactless interface.

Another way of proceeding consists of first depositing all the cards in the stock on the contactless interface and secondly those of the discard. The contactless interface is then provided with an anti-collision system for identifying each of the cards constituting the packet placed on this interface. After this step 32, the terminal 17 knows all the cards in the stock and discards.

During a step 33, a recording is made with the game elements in the position of the players at the moment of interruption of the part and by means of the master elements. This step may consist of identifying first of all one of the players by means of his master card and then identifying each of the cards contained in his hand. The same procedure is followed for each of the other players. Another way of proceeding consists of placing on the contactless interface the master card of a player as well as those constituting his hand. Once the master card and the hand are recognised, the master card and the cards constituting the hand of each of the other players are recorded.

Step 34 is an end step.

The terminal 17 in this way records not only (like a photograph) the state of the game at the moment of its interruption, but also the history of the unfoldment of the part of the game (like a film). It is consequently possible subsequently to faithfully restore the state of the game as it was at the moment of interruption.

In a first embodiment of the invention, the partial game remains stored at the terminal 17. The game can therefore be resumed by the players subsequently when they are once again around this terminal.

In a second embodiment of the invention, the partial game is stored at an Internet server. The players can then download the games stored onto another terminal in order to pursue their part.

In a third embodiment of the invention, the partial game, after having been stored at the terminal 17, is transferred into one of the master cards. When the players meet again, the partial game will be copied from the master card storing the partial game to a game terminal.

In a fourth embodiment of the invention, the partial game is partly recorded in each of the master cards. In this way it will be able to be continued only when the same players are once again around a gaming terminal.

The partial game stored may be encrypted, for example by the public keys of the players.

FIG. 3 is a diagram showing the various steps of the restoration method according to the invention.

This is here in the context of a resumption of a game previously interrupted and recorded, for example as it is at the time of the end step 34 in FIG. 2.

Step 40 is a start step.

During a step 41, the history of the unfoldment of the interrupted game part is restored. This restoration may be done starting from a recording at the terminal, an Internet server to which a terminal is connected, a master card or the master cards of the various players, as seen previously.

In order to protect access to the game, an authentication of the players may be demanded by the terminal or server. In this case, the players authenticate themselves by means of their master cards and/or using passwords (PIN codes).

The restoration of this history enables the players to separate out the game elements already played during the interrupted part. They are for example displayed on the terminal screen.

During a step 42, any game elements that may not have been played are identified. These game elements are for example displayed on the screen of the terminal so that the players can put them on one side (on a stock and/or a discard).

During a step 43, the game elements to be allocated to each of the players are identified. This identification is done by means of the master elements, for example in the case of cards according to the following scenario: a first player puts his master card close to the contactless interface in order to identify himself. He then presents to the interface the remaining cards one by one (those of the hands of all the players). These presentations are made by presenting the diagram of the card turned towards the interface, so that the players do not see the cards of the different hands. The terminal indicates, when each card is presented, whether or not it belongs to the hand of this first player. The first player keeps the cards constituting his hand and separates those that are not his. Once the first player has reconstituted his hand, it is the turn of the second player (who proceeds likewise with the cards separated out by the first player), until the last player. In this way, each player can recover his hand without the other players being able to take cognisance thereof.

In another embodiment, each card is presented to the contactless interface and the terminal indicates to which player it should return (the players have previously all identified themselves).

Step 43 is followed by an end step 44 corresponding to the re-establishment of the situation of the game as it was when it was interrupted, and the game can then resume.

In a particular embodiment, a password is allocated to each recorded part, so that several parts of the same game (played between the same players or between other players) can be recorded. The same character in a game will thus have different levels but for different parts played. A player can thus begin several parts of the same game with the same game partner (or another game partner) without any of the parts being ended and also restore the part that they decide to continue.

The invention also applies to money games without risk between two parties. A part commenced between Alice and Bob can be continued only between Alice and Bob.

The invention also makes it possible to offer game decks for sale, with playing cards (characters) having different levels (the higher the level of the cards played, the higher its price). It is also possible to sell fictitious parts to be restored by players, with ad hoc cards.

The purchase of parts encrypted by PKI (by the public key of the purchaser) can also be imagined.

1. A method for saving the state of part of a game played by at least two players, said game comprising game elements with chips able to communicate without contact with a terminal via an interface, said terminal comprising a screen, said game including presenting said game elements to said interface, each player being identified by said terminal by a game element referred to as a master element, said saving method comprising:
recording the history of the unfoldment of the part of the game,
recording any game elements that may not have been played, and
recording the game elements in the possession of the players at a time of interruption of the part by means of the master elements, so as to be able subsequently to resume the part in the same state as it was at the time of the interruption.

2. A method according to claim 1, wherein said game elements comprise contactless cards each comprising a diagram.

3. A method according to claim 1, wherein the recording of the game elements that have not been played comprises the recording of the game elements included in a stock.

4. A method according to claim 1, wherein said recordings are made in one of said master cards.

5. A method according to claim 1, wherein said recordings are shared between the master cards of said players.

6. A method according to claim 1, wherein said recordings are made at said terminal.

7. A method according to claim 1, wherein said recordings are made at a server to which said terminal is connected.

8. A method according to claim 1, further comprising a step of saving the game elements that have been played into a discard pile.

9. A method of restoring part of a game played by at least two players, said game comprising game elements with chips able to communicate without contact with a terminal via an interface, said terminal comprising a screen, said game including presenting said game elements to said interface, each player being identified by said terminal by means of a game element referred to as a master element, said restoration method comprising:
restoring the history of the unfoldment of the part of the game,
identifying any game elements that may not have been played,
identifying the game elements to be allocated to each of the players by means of the master elements.

10. A method according to claim 9, wherein said game elements comprise contactless cards each comprising a diagram.
